(19) United States
(12) Patent Application Publication
(10) Pub. No.: US 2002/0120508 A1
(43) Pub. Date: Aug. 29, 2002

(54) Point managing method

(76) Inventors: Kiyotaka Matsumoto, Saitama (JP); Mutsuki Koga, Ichikawa (JP); Yasuhiko Sugiyama, Chigasaki (JP)

Correspondence Address: CROWELL & MORING, LLP, P.O. Box 14300, Washington, DC, 20044-4300, US

(21) Appl. No.: 10/045,022

(22) Filed: Jan. 15, 2002

(30) Foreign Application Priority Data
Jan. 15, 2001 (JP) 2001-5896

(51) Int. Cl. G06F 17/60

(52) U.S. Cl. 705/14

(57) ABSTRACT

Terminals of individual registered members of service users 3 and service providers 4, and terminals of a hosting business association 2 are connected with a communication mean 5, member information recording media 6 which can be attached to the terminals of the individual members are delivered, prescribed points are given to the service provider 4 when the service user 3 receives a service from the service provider 4, and a service is received, or an article is purchased or lent based on point conversion according to the accumulated points.

### BACKGROUND OF THE INVENTION

The present invention relates to a point managing method, and specifically relates to a point managing method where both service providers and service users are members, and the service is a point system.

Prior art for a service method relating to care is described in the Japanese patent specification No. 2673798. In this method, a card with recorded points is issued to an authorized care organization on an application from an insured person, and a service providing organization subtracts points corresponding to a care service provided for the insured person from the card, and reports a record of the service to an insurance organization. The insurance organization instructs a fund pool organization to pay a service fee to the service organization based on the record data, and to supply a benefit corresponding surplus points recorded on the card, and the fund pool organization pays the care service fee, and supplies the benefit corresponding to this instruction. In conventional proposals including this example, the users are limited to the insured people, and it is not considered how to treat service providers, for example.

Lack of volunteers in social welfare and event field as well as care field has become a serious problem recently. On the other hand, livelihood protection and rewards for volunteers are institutionalized in Europe, and volunteers are socially recognized.

In this situation, for example, though a care insurance system started in the care field April 2001 in Japan, for example, since an operating body is committed to the individual autonomies, an application criteria of the care insurance varies from one autonomy to another, and a complicated procedure is necessary for the application. Also care business associations have not achieved expected sales, and have to review their business. One reason is that the care insurance pays not for “Physical Care” with the highest payment, but for “Residential Care” with the lowest payment most often, and personnel expense for helpers cannot be covered.

The present invention focuses on allowing a care receiver to receive cares from volunteers whether the care insurance is applied to the care receiver, thereby solving problems such as application criteria of the individual autonomies, and the complicated procedure. It is expected that the care business associations can specialize in “Physical Care” which requires high level knowledge and experience of the first and second class helper qualification to increase profits. Though the present invention is triggered by the care and the volunteers, the present invention is not limited to their contracts, and can be applied to entire contracts between service users and service providers.

### SUMMARY OF THE INVENTION

The present invention supplies points to the service providers according to the degree of the services from the service providers, thereby increasing the number of the service providers, and using accumulated points to activate the service.

Service operations of the present invention has a characteristic that terminals of individual members of multiple service users and service providers registered as members, and terminals of a hosting business association are connected with communication mean, member information recording media which can be attached to the terminals of the individual members are delivered, prescribed points are given to the service provider through the terminal and the recording medium when the service user receives a service from the service provider, and a service is received, or an article is purchased or lent based on point conversion according to the accumulated points, or that terminals of individual members of multiple service users and service providers registered as members, and terminals of a hosting business association are connected with the Internet, member information recording media which can be attached to the terminals of the individual members are delivered, prescribed points are given to the service provider through the terminal and the recording medium when the service user receives a service from the service provider, and a service is received, or an article is purchased or lent based on point conversion according to the accumulated points.

It is preferable that the medium is a member authentication (such as member card) with an IC card or a cellular phone (including a PHS terminal) in the present invention, and the service provider is a care giver and the service user is a care receiver in an example applied to a care field.

The present invention is especially applied to care, and can provide a system where points are accommodated between a care receiver and a volunteer in an organization comprising members. Namely, a care receiver purchases points in advance, and pays by the points as a reward when the care receiver receives a care. The volunteer can purchase articles according to gained points, can convert the points into services such as using facilities, and the volunteer himself/herself or his/her family members can receive care.

As a mean for applying for a volunteer as a group of members, receiving/providing points, and converting points, the Internet can be used, and a dedicated search system, electronic shopping, and the like can be used.

A function for matching volunteer conditions (such as an area, date and time, and a content) by means of a volunteer search system, and a function for guiding a volunteer to a service user with a navigation system are provided.

This system can be applied to social welfare, and event fields as well as the care field for securing volunteers, and will be an effective mean for solving lack of volunteers.

Recording media is electronic media such as IC cards and portable terminals in the present application. A cellular phone is an example of the portable terminal. The actual media can be delivered, or a function can be delivered through a communication mean to media as delivering the recording media to the members. The IC card includes delivering an actual card, or downloading to an IC card. As for the portable terminals, though delivering software can make the terminals the media, the operation method of the present invention includes authenticating through access to a point managing site. Though if the member certificate and the matching are delivered through the communication mean, a service provider can bring the medium to a member shop for a contract such as purchasing an article when the points are used later, the present invention includes an operation where the management itself is committed to an ASP company without accumulating the points in the portable terminal.

When the medium of a service provider (whether it is owned or lent) is an IC card, and the medium of a service user is an IC card as well, it is easy to use a dedicated terminal to move points from the IC card of the service provider to the IC card of the service user. Data read in an IC card reader can be returned from the IC card reader for example. It is possible to exchange points through an electronic wallet which can store two cards at the same time such as electronic money. When an IC card reader/writer is connected to a personal computer, IC cards are inserted alternately to move points. It is possible to operate such that points are moved at a member shop where an IC card reader/writer is installed when an IC card reader/writer is not available. Points are exchanged between cellular phones when they are connected with a communication mean. It is convenient to use an IC card reader with a radio function between a cellular phone and an IC card, and it is possible to move points through a personal computer (using P/W).

### BRIEF DESCRIPTION OF THE DRAWINGS

FIG. 1 is a conceptual illustration for how to manage points relating to an embodiment of the present invention.

FIG. 2 is an illustration for a business relationship relating to an embodiment of the present invention.

FIG. 3 is an illustration for describing a flow of point issuing relating to an embodiment of the present invention.

FIG. 4 is an illustration for describing a flow of services and corresponding values relating to an embodiment of the present invention.

FIG. 5 is a transition diagram for Internet screens relating to an embodiment of the present invention.

FIG. 6 is a transition diagram for Internet screens relating to an embodiment of the present invention.

FIG. 7 is a transition diagram for Internet screens relating to an embodiment of the present invention.

FIG. 8 is a transition diagram for Internet screens relating to an embodiment of the present invention.

FIG. 9 is an illustration for showing an example of a network relating to an alternative embodiment of the present invention.

FIG. 10 is an image illustration for point management in the example in FIG. 9.

FIG. 11 is an illustration for describing a system for issuing IC cards in the example in FIG. 9.

FIG. 12 is an illustration for describing a system for issuing points in the example in FIG. 9.

FIG. 13 is an example of a shop search screen shown on a terminal display in the example in FIG. 12.

FIG. 14 is a descriptive illustration for using a CRM of participant shops in the example in FIG. 9.

FIG. 15 to FIG. 21 are illustrations for showing examples of devices for moving points.

### DETAILED DESCRIPTION OF THE PREFERRED EMBODIMENTS

The following section describes embodiments of the present invention while referring to drawings.

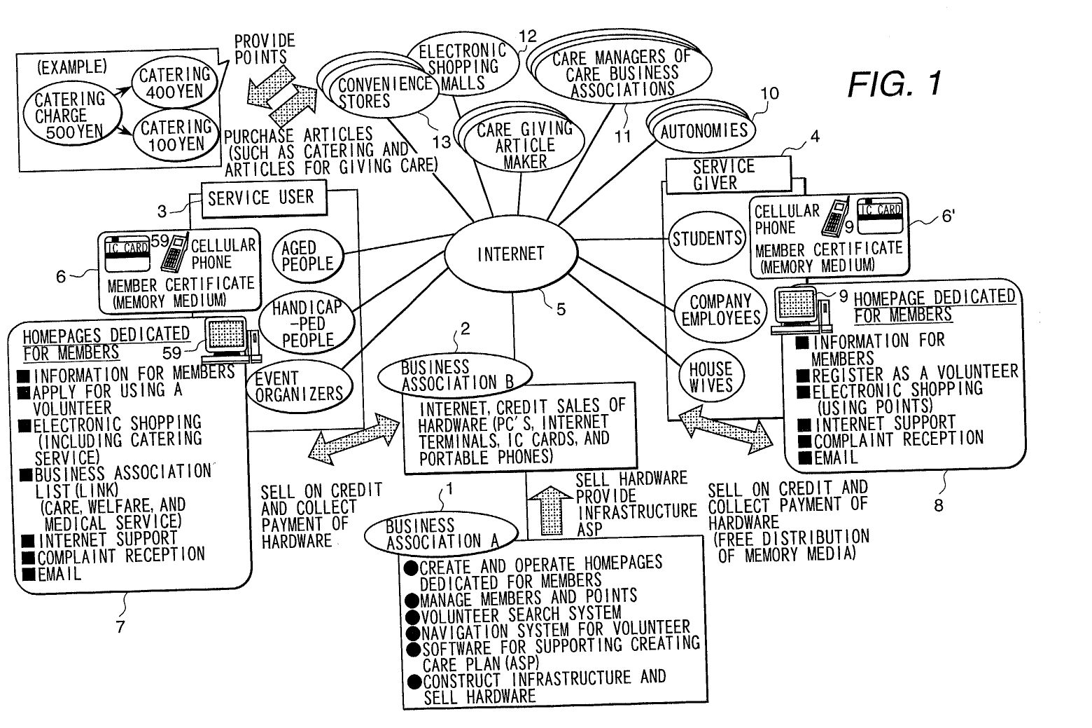

FIG. 1 shows a concept of a network for a point managing system.

A business association A 1 (1) creates and operates homepages dedicated to members, (2) manages the members and points, (3) operates and manages a volunteer search system, (4) operates and manages a navigation system for volunteers, (5) provides software for supporting care plan creation through ASP (Application Service Provider), and (6) constructs an infrastructure, and sells hardware. Selling in (6) can be replaced with lending.

A business association B 2 is a credit company, for example, and purchases hardware from the business association A 1. The business association B 2 sells the hardware on credit. Examples of the hardware include tools relating to the Internet, computers (Personal Computer (PC)), mobile terminals, dedicated Internet terminals, TV's and the like), IC cards, cellular phones (including PHS terminals), and IC card R/W's. When one already owns an IC card or a cellular phone serving as a member authentication medium, they can be used if they have the similar functions/specifications. It is possible to constitute one business association comprising the business association A 1 and the business association B 2.

Members comprise service users 3 and service providers (volunteer in this example) 4, and both of them comprise multiple members. The service users 3 comprise, for example, aged people, handicapped people, and event organizers, the service providers 4 comprise, for example students, company employees, and house wives, which are individuals in principle, and the application range of the present invention includes groups such as a corporate body in an event and the like. The service users 3 and the service providers 4 can switch their roles and positions accordingly, namely the service provider may be the volunteer, or the volunteer may be a service user.

The business association B 2 sells hardware on credit to, and collects a payment from the service user 3. Simultaneously, the business association B 2 sells hardware on credit to, and collects a payment from the service provider 4. When the service provider 4 is a volunteer, the recording medium for serving as the membership function (electronic medium such as IC card 6′ and a cellular phone) is delivered for free in the present embodiment. If the recording medium is a portable terminal such as a cellular phone, downloading software may realize a member certificate function.

The terminals of the individual members and the terminals of the business association A 1 are connected for communication with the Internet 5, and information is communicated, the terminals of the members may be ones owned by the members, and when a member does not own a terminal, the business association A 1 or the business association B 1 can lend or give a terminal. The lending and giving is a concept including lending and giving for free. The recording medium 6 such as an IC card for serving as a point card and a member certificate simultaneously are delivered to the individual members, and points are added to/subtracted from the recording medium 6 through a terminal or between the receding media.

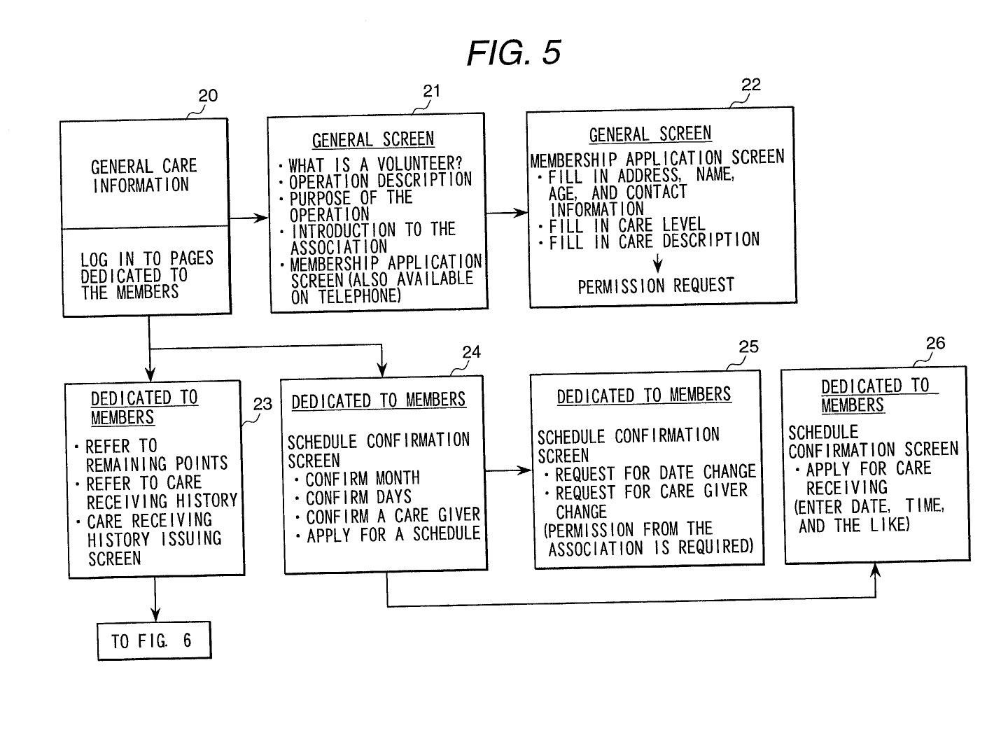

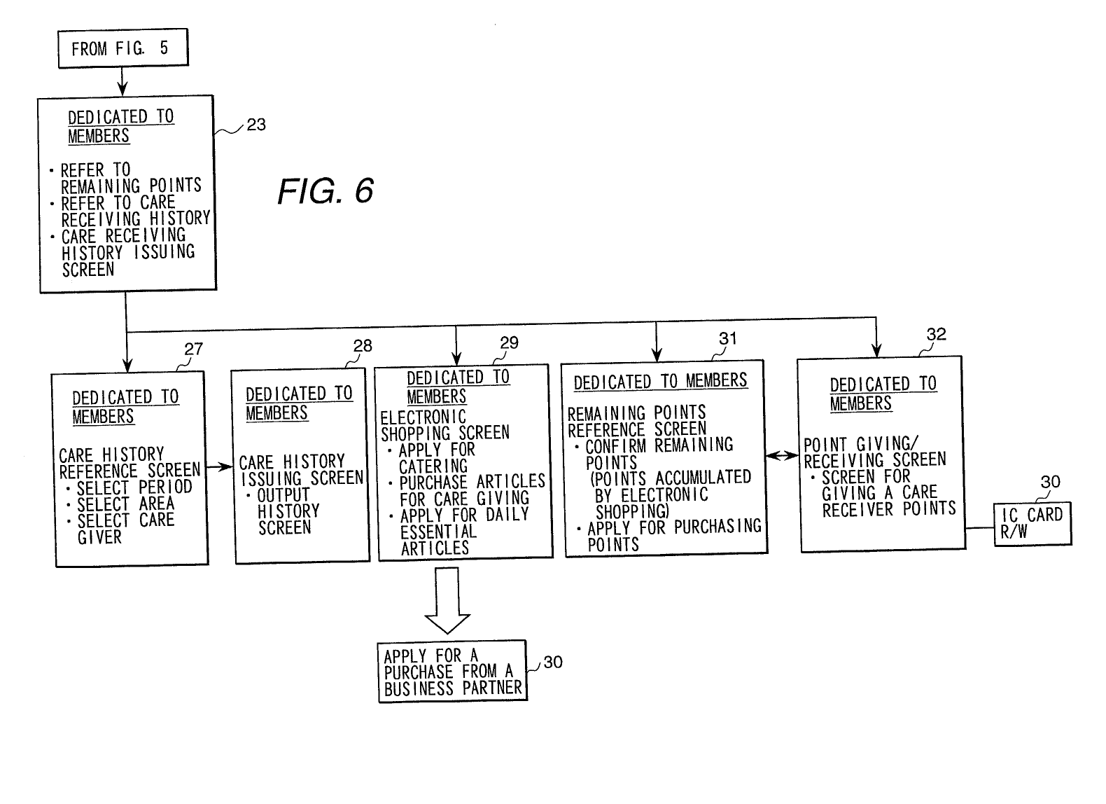

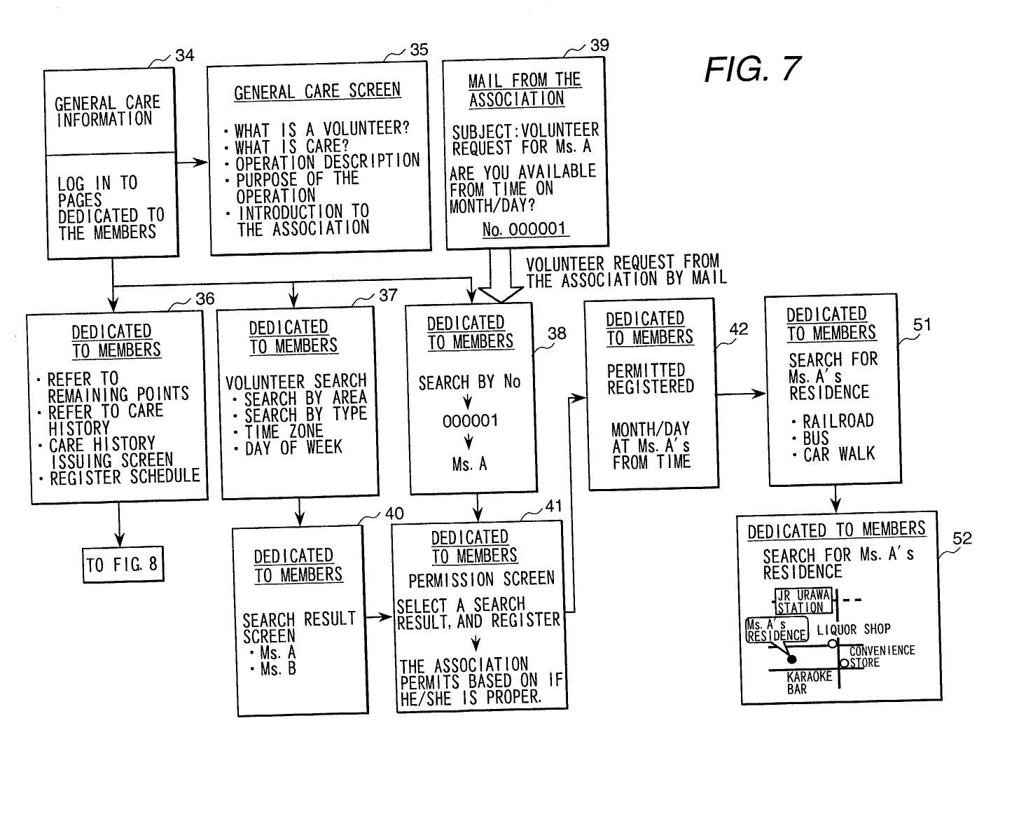

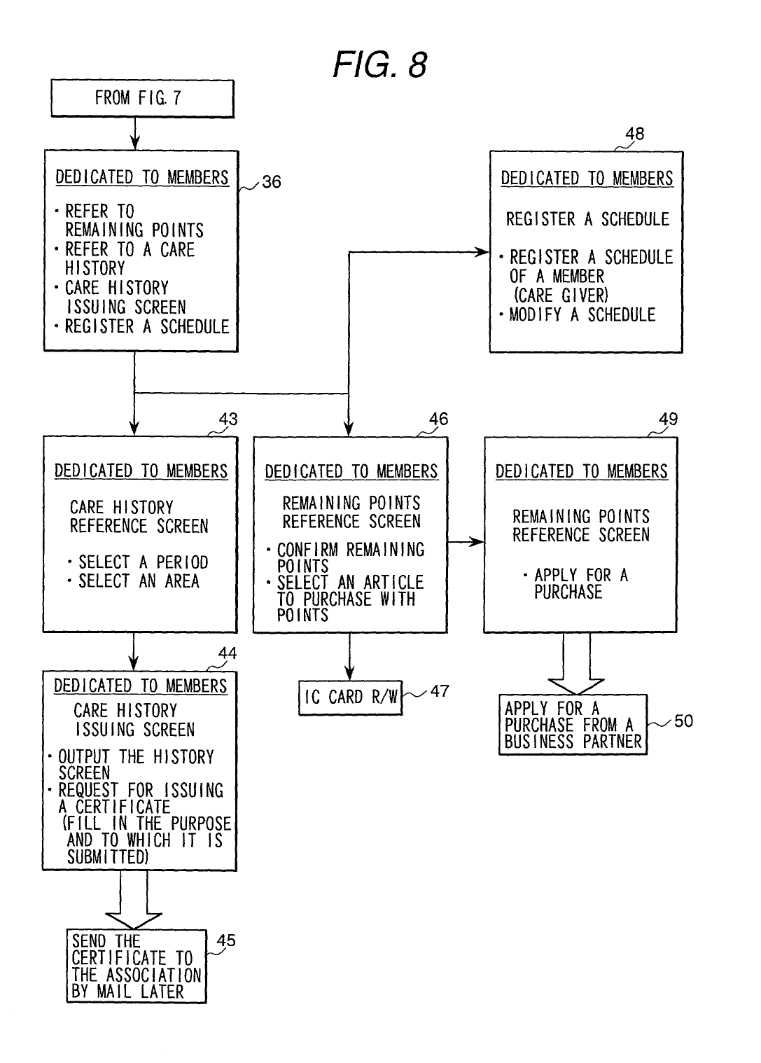

Dedicated homepages 7 and 8 are provided for/disclosed to the individual members through the Internet 5, (1) information for the members, (2) application for requesting a volunteer, (3) electronic shopping (including a catering service), (4) business association list (such as care, welfare, and medical service. Linkable), (5) Internet support, (6) complaint reception, and (7) email are available for the service users 3, and (1) Information for members, (2) registering as a volunteer, (3) electronic shopping (using points), (4) Internet support, (5) Complaint reception, and (6) E-mail are available for the service providers 4. FIG. 5 and FIG. 6 show an example of Internet screen transition drawings for the service users 3, and FIG. 7 and FIG. 8 show an example of Internet screen transition drawings for the service providers 4.

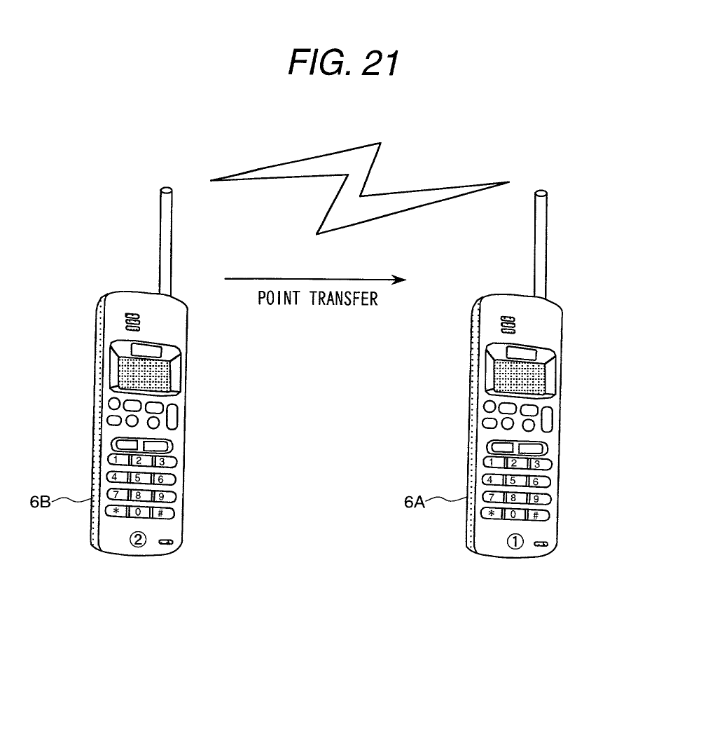

The following section describes the Internet screen transition for the service users 3 while referring to FIG. 5 and FIG. 6, and screen 20 shows a section for general care information and logging to pages dedicated to the members. A general screen FIG. 21 shows a content for presenting “What is a volunteer?”, “Operation description”, “Purpose of the operation”, “Introduction to the association”, and “Membership application screen (also available on telephone)”, and a general screen FIG. 22 becomes a membership application screen for showing entries for one's address, name, age, and contact information, and allows requesting permission after filling in a care level and a care description. This membership application screen 22 is an example of membership application mean, the reception is also available on telephone or by mail, and the association operates the permission for membership applicants. When one logs in the page dedicated to the members, a screen dedicated to the members 23 appears, and allows showing and selecting from “Refer to remaining points”, “Refer to care receiving history”, and “care receiving history issuing screen”. After this, the procedure moves to a screen transition diagram in FIG. 6. A screen for dedicated to the members 24 is a schedule confirmation screen, allows deploying to confirming a month, confirming days, and confirming a care giver, and also allows applying for a schedule. Namely the deployment reaches to deployment screens 25 and 26, the deployment screen 25 allows requesting for date change, and requesting for care giver change, and the deployment screen 26 allows applying for care receiving. The request for changing a care giver requires admission from the association, and the application for care receiving requires for entering the data and the time.

The screen for dedicated to the members 23 moves to any one of screen 27, screen 29, screen 31, and screen 32. The screen 27 allows selecting a period, selecting an area, and selecting a care giver as a care history reference screen, further moves to a care history issuing screen for allowing an output of the history screen. The screen 29 is an electronic shopping screen, allows requesting catering, purchasing articles for care giving, and requesting daily essential articles, and selecting any one of them leads to a step of applying for a purchase from a business partner. The screen 31 is a remaining points reference screen, and allows confirming remaining points, and applying for purchasing points. Points are accumulated through electronic shopping in the remaining point confirmation. The screen 32 is a point giving/receiving screen, and shows a screen for giving a care receiver points. Hardware is constituted such that the information is accumulated in an IC card or a R/W.

The following section describes an Internet screen transition for the service providers 4 while referring to FIG. 7 and FIG. 8, and a first screen 34 shows general care information and logging to pages dedicated to the members. When the general care information is selected, a general screen 35 appears, and allows selecting “What is a volunteer?”, “Operation description”, “Purpose of the operation”, and “Introduction to the association”. When the screens dedicated to members are selected, the screens dedicated to members 36, 37, or 38 appears. The screen 36 allows selecting screens for “Refer to remaining points”, “Refer to care history”, “Care history issuing screen”, and “Register schedule”. The screen 37 allows volunteer search, and one can check with search by area, search by type, time zone, and day of week. The screen 38 allows member number search, and shows a mail for volunteer request from the association, “Subject: Volunteer request for Ms. A, Are you available from Time on Month/Day”.

The screen 37 moves to a search result screen 40, and shows applicable members. The screen 40 and the screen 38 move to a permission screen 41, one can select a search result and register it, and the association permits based on if he/she is proper. Then, the procedure moves to a screen 42, and shows the screen for permission, registration, and confirmation.

The screen 36 moves to a care history reference screen 43, a remaining points reference screen 46, or a schedule registering screen 48 according to the selection, and the screen 43 allows selecting a period, and an area before moving to a care history issuing screen 44. The screen 46 allows confirming remaining points, and selecting an article to purchase with points, and the information is accumulated in an IC card and a R/W. The screen 48 allows registering a schedule of a member (care giver), and modifying a schedule. The screen 44 allows outputting the history screen, and requesting for issuing a certificate (fill in the purpose and to which it is submitted), and the certificate is sent to the association by mail later as shown in a process 45. A remaining points reference screen 49 following the screen 46 allows an application for a purchase, and allow an application for a purchase from a business partner as shown in a process 50.

It is also possible to purchase points at a prescribed price for addition them. It is also possible to add/subtract points when the recording medium 6 is inserted into a terminal.

Individual terminals 9, 10, 11, and 12 for care giving article makers, autonomies, care managers of care business associations, electronic shopping malls, and convenience stores are connected with the Internet 5 to link to the association list described above as well. The service user 3 can purchase articles such as catering and care giving articles from the convenience stores and the electronic shopping malls, and supply points to a purchasing party when purchasing articles. If a catering charge is 500 yen, it is valid to distribute 400 yen for the catering and 100 yen to equivalent points.

On the other hand, the service provider 4 can use accumulated points to purchase articles from the electronic shopping mall, the convenience store, or the business association A, and it is possible to pay a deficient amount on credit for the purchase. In place of these purchases, it is possible to rent. It is possible to directly bring in the recording medium 6 in place of a terminal owned by a member to a store or the business association A to provide it for settlement.

The individual parties have the following roles and merits in the embodiment above.

The service user 3 purchases the recording media 6 when applies for the membership. If the service user 3 wants to purchase dedicated hardware/an Internet terminal, the service user 3 requests and purchase it from the business association B 2 (credit company) such as a credit company. The service user 3 pays on credit when the service user 3 pays for an annual fee or purchases the hardware/Internet terminal. It is possible to purchase articles from prescribed convenience stores through the homepages dedicated for the members to gain points. When the service user 3 requests a volunteer service, and receives a service from a volunteer, the service user 3 directly pays by points in response. As described above, aged person as the service user 3 can use the services without applying for the care insurance and its procedure with “Residential Care” level, and aged people and handicapped people can use different services such as request for a volunteer from home through the Internet.

The recording medium 6 is provided for the service provider 4 for free when applying for the member. If the service provider 4 wants to purchase dedicated hardware/an Internet terminal, the service provider 4 requests and purchases it from the business association B 2 (credit company) such as a credit company. The service provider 4 registers intended volunteer conditions (such as the date, the time, and the content) through the homepage dedicated for the members. When the service provider 4 is requested for a volunteer service through the homepage dedicated for the members, the service provider 4 answers whether accept it or not. When the service provider 4 accepts the request, the service provider 4 can use a navigation system to go to a service user. When the service provider 4 uses points obtained through the volunteer service to purchase articles, the service provider purchases them at predetermined electronic shopping malls and predetermined shops. A settlement mean follows a rule in the electronic shopping mole in case of shopping at the electronic shopping mole. As described above, the service provider 4 accumulate points through the volunteer action, the points are returned as an article service, the service provider 4 himself/herself or his/her family members can receive volunteer services, and the service provider can certify his/her social value through the volunteer history and gained points.

A care business association can link the homepages dedicated to the members with its own homepages in addition to paying for a user fee (royalty). The care business association specializes in “Physical Care” with a high reward to secure profit, and uses a network to people requiring cares to provide a service for creating care plans, to increase the efficiency, and enclose service users.

A convenience store as a point using business association pays royalty (user fee), issues points when the service user 3 purchases an article, and sells an article to a volunteer (service provider 4) with point settlement. This business association adds points when aged people and handicapped people purchase a catering service or care giving articles to enclose the service users, and the volunteer converts points into articles at the convenience stores and the electronic shopping malls to activate the electronic shopping mall operated by this business association.

The business association A 1 creates and operates homepages dedicated for the members, manages the members, manages points, develops and operates a volunteer search system/a navigation system for the volunteers, and sells dedicated hardware, Internet terminals, and IC cards to the business association B 2 (such as credit company). The business association A 1 can sell different services (such as member management software, point management software, and care plan creating software) through an ASP, and can sell hardware infrastructure such as Internet terminals, hardware, and recording media.

The business association B 2 sells dedicated hardware, Internet terminals, and receding media (provided for the service providers for free) on credit.

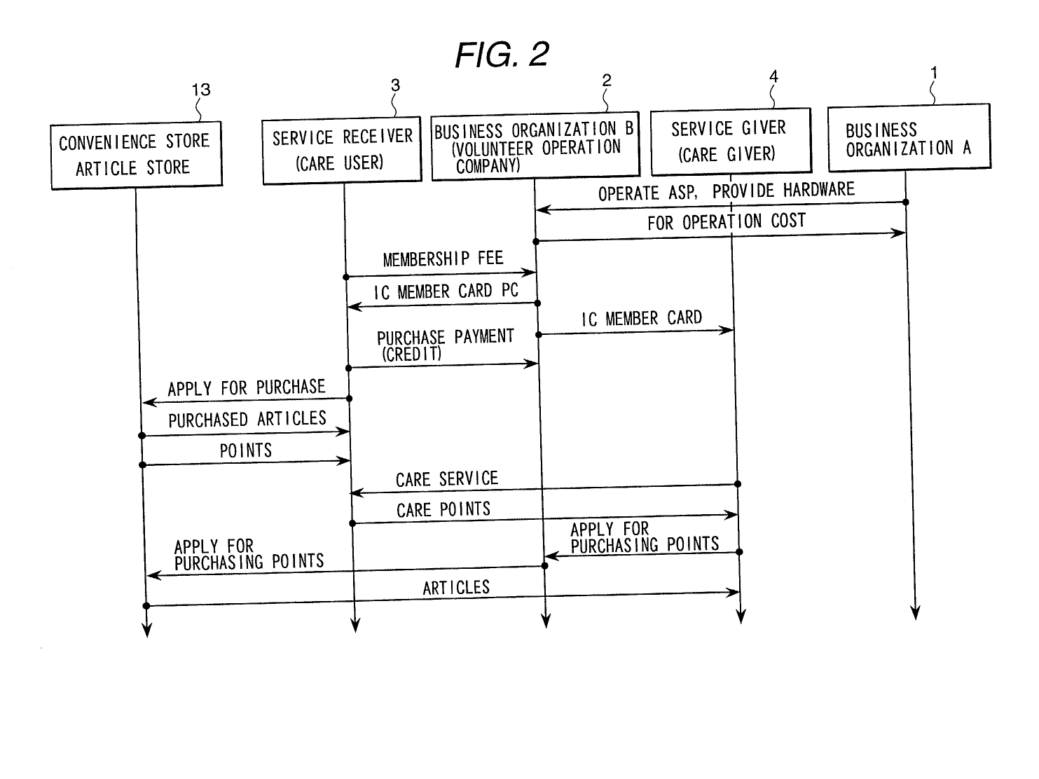

FIG. 2 shows a business relationship among relating parties in the embodiment above, and the following section describes it. The business association A 1 provides the business association B 2 with the ASP operation and hardware, and the business association B 2 pays an operation fee. The service users 3 pay membership fees to the business association B 2, and are provided with receding media 6 and the hardware (unless the service users 3 have). The business association B issues recording media 6 for the service providers 4 on membership registration. The business association B collects purchase payments (credit is available) for providing PC's and the like from the service users 3.

The service user request a purchase of intended articles (including catering) from a store for selling articles such as the convenience store 13, and obtains the purchased articles and points corresponding to the purchased price as well. The service provider 4 provides the service user 3 with a care service, and obtains care points in return. The service provider 4 requests for purchasing point from the business association B 2, the business association B 2 transfers the request to a store for selling articles such as the convenience store 13 in response, and the corresponding article is returned to the service provider 4.

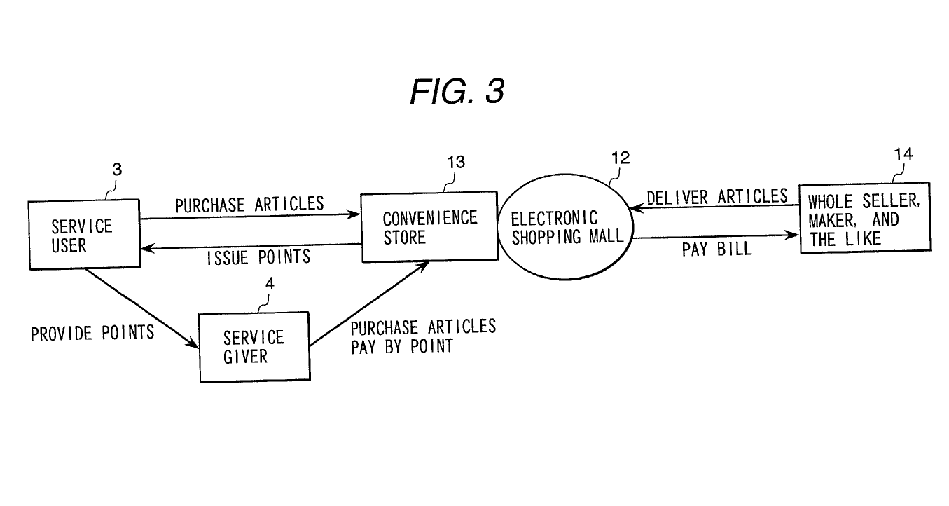

The following section describes a flow of issuing points while referring to FIG. 3. Points are issued when the service user 3 purchases articles at the convenience store 13 and the electronic shopping mall 12. These shops 11 and 12 purchase corresponding articles from whole seller, makers, and the like 14, and pay for them. The service user 3 who receives a volunteer service supplies the service provider 4 with the points, and the service provider 4 purchases articles by the points at a store such as the convenience store 13.

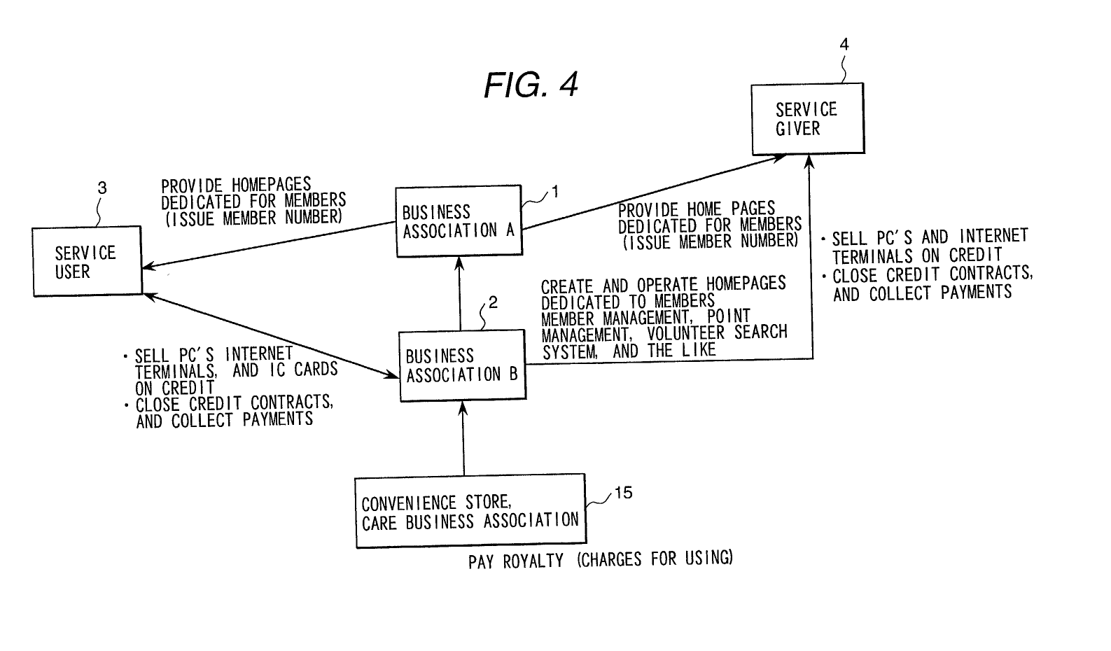

The following section describes a flow of operations at the individual business associations while referring to FIG. 4. The business association A 1 receives fees for using from the convenience store and the care business association 15 through the business association B. The business association A creates and operates the homepages dedicated to the members, and provides the business association B with member management, point management, a volunteer search system, a navigation system for the volunteers, and the like. The business association A issues a member number to the service provider 4, and provides it with the homepages dedicated to the members. The business association A issues a member number to the service user 3, and provides it with the homepages dedicated to the members. The business association B 2 sells hardware and an Internet terminal on credit to the service user 3, closes a credit contract, and collects the payment. Namely the business association B receives an infrastructure from the business association A, and operates the business.

There are certain rules in the present embodiment, and they include (1) The search system using the Internet matches the volunteer conditions (an area, a date and a time, and a content) to reduce loads (such as transportation expenses, and binding hours) on the volunteers, and the navigation system for the volunteers leads to a residence of a service user to increase the convenience, (2) The points are not directly supplied to the students, but to individual schools, and a volunteer history is written to the receding media 6 of the corresponding students when the volunteers are students (primary school and high school), and (3) Both the service users and the volunteers with a large number of complaints are removed from the members.

Rules for collecting payments include (1) Points are supplied as an addition to articles purchased from the convenience stores and the business partners, and points are exchanged to articles at the convenience stores and the electronic shopping malls operated by the business partners, (2) The recording media 6 are distributed to the volunteers for free, and the cost for the receding media 6 is collected by selling to the service users (a sale on credit is available), and (3) The business association B collect annual fees from the service users, and royalties from the convenience stores and the care business associations, and they are used for collecting system operation cost and management cost of the business association A 1.

With the present embodiment, the service users 3 can always use the service providers 4. Removing complicated procedures and the like facilitate receiving services. The service users 3 and the service providers 4 can smoothly purchase and exchange articles through the network. The service providers 4 can collect information on and participate in not partial and limited volunteer activities, but volunteer activities across a wide range. The service providers 4 can socially certify the volunteer activities.

On the other hand, the business association B 2 can manage and recognize the service providers 4 which conduct the volunteer activities, thereby promoting using proper quality and quantity of human resources.

The business association A 1 can be effectively applied to other member management in addition to the volunteer activities.

Using points eliminates monetary troubles, and increases desire to the volunteer activities, and it is possible to obtain a synergetic effect comprising social (ethical) education through the volunteer activities, and a financial aid to the school when the service provider 4 is a school juridical person.

The present embodiment is used by both the service providers and the service users as described above, the service provider can check recorded service points from his/her home, and can ask for issuing a certificate for volunteer activities. Articles can be purchased through electronic shopping using the Internet according to points. The service user can purchase points with an IC card, or with care relating articles through electronic shopping on the Internet. Using the Internet is an important point in the present embodiment, and guidance and introduction mailed to both the service users and the service providers, and Internet search are realized in addition to the electronic shopping described before. The entire present system can be recognized as an ASP, and can be provided for not only one user organization, but also for multiple user organization, and multiple services.

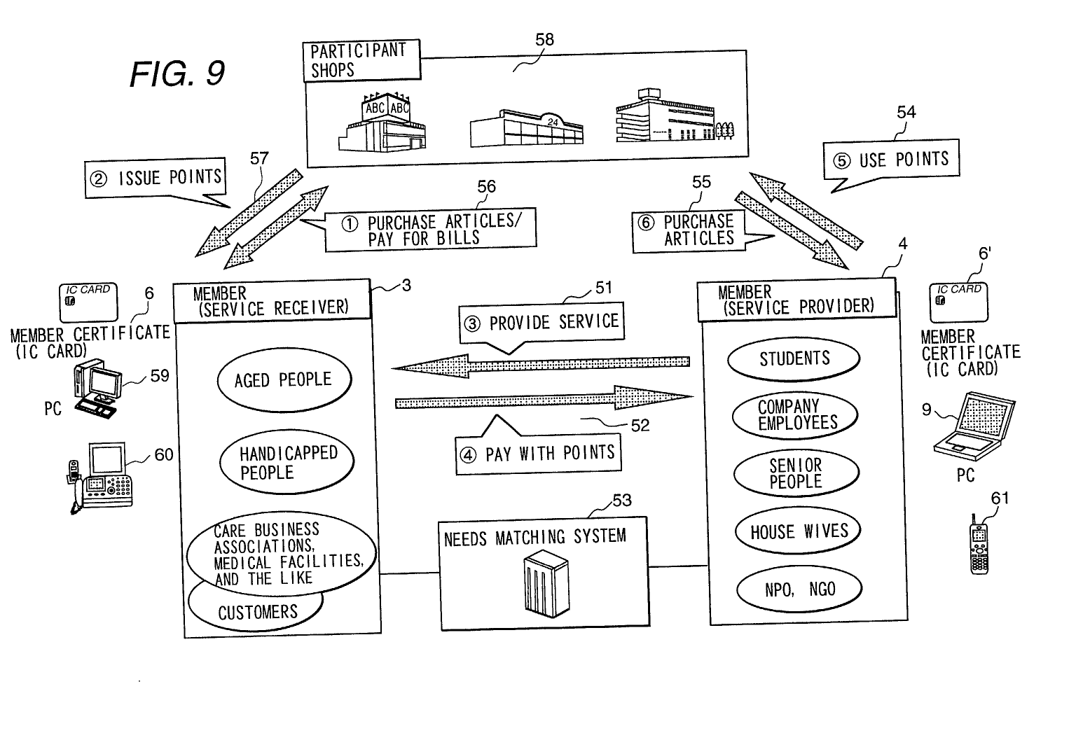

FIG. 9 describes an alternative embodiment of the present invention. There are multiple members as service providers 4 and members as service users 3 as the embodiment described before. The service users 3 may be customers such as care business associations and medical facilities in addition to the aged people and handicapped people in the present embodiment. The service providers 4 include students, company employees, senior people, house wives, NPO's and NGO's.

A needs matching system 53 is interposed between both of them, and promotes matching between needs and seeds of both of them. Examples of needs include wanting to sell, wanting to buy, wanting a chatting companion, wanting training for PC operation, and wanting advice on managing assets.

Tools used for the individual operations of the individual members include a member certificate 6′, a PC 59, a mobile terminal 61, and a simple Internet connection service using telephone (home telephone 60) with a liquid crystal device. Making a magnetic card into an IC card increases the security of a credit card. Using the simple Internet connecting service, and the PC operation training facilitate the use of the Internet by aged people.

The service provider 4 provides the service user 3 with a service after using the needs matching system 53 (51), and the service user 3 pays by point to the service provider 4 (52). The service user 3 purchase articles from, and pays payments to a member shop 58 (56), and the member shop 58 issue points to the service user 3 (57). The service provider 4 uses points (54), and purchase articles and services from the member shop 58 (55). The points and CRM allows enclosing customers with respect to distributors and economic trend in this way, service bases and stores are activated, pulling customers increases sales, and enhancing services for consumers allows growing out from stagnant consumption.

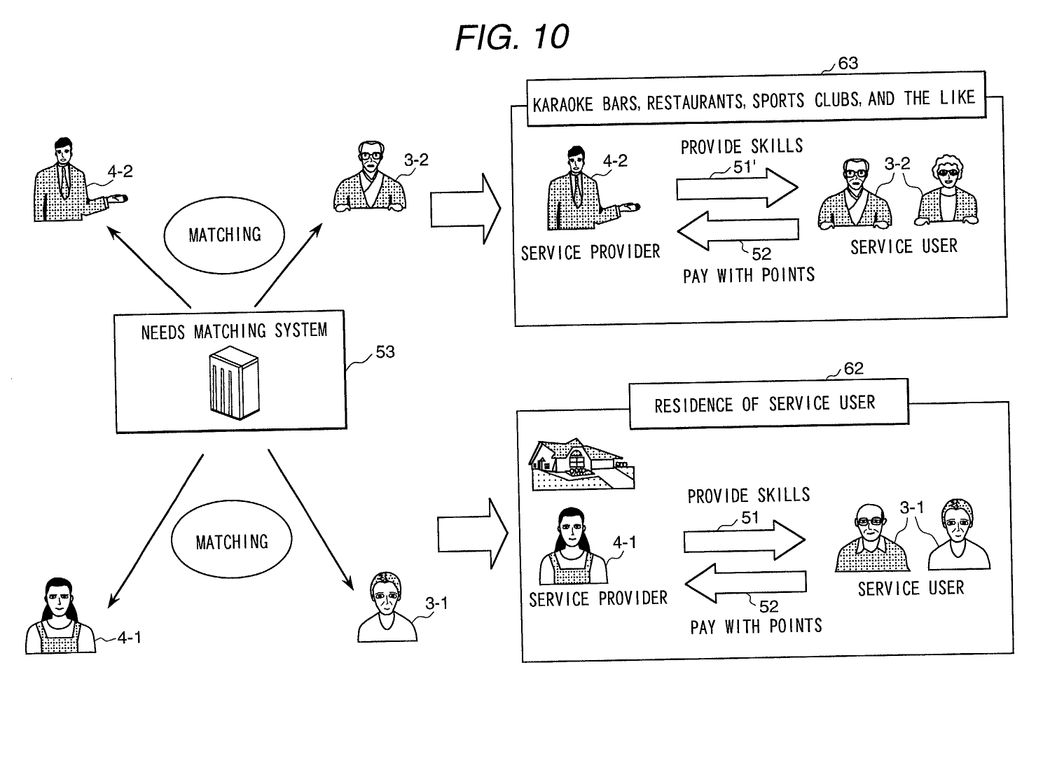

FIG. 10 shows an operation image of an example of FIG. 9. Service providers include a provider 4-1 and a provider 4-2, and service users include a service user 3-1 and a service user 3-2 in this example. The provider 4-1 is thinking, “I have a spare time this week, and want work as a volunteer”, and the provider 4-2 is thinking, “I have skills in stocks and credits.” The user 3-1 is aged, and thinking, “I want to rearrange my room, but I have a low back pain”, and the user 3-2 has a trouble in “asset management”. The matching system 53 matches the provider 4-1 with the user 3-1, and the provider 4-2 with the user 3-2 in this case. The provider 3-1 provides the user 4-1 with a service at the residence of the service user 62. Namely the service provider 4-1 visits the residence of the service user 3-1, and provides the service. This type of services include taking a dog for a walk and serving as a chatting companion in addition to rearranging a room. The user 3-1 pays by point in response to the provided service 52. The provider 4-2 is matched with the user 3-2, and the service is received at a facility outside the residence such as a karaoke bar, a restaurant, and a sports club 63. In this case, the service is providing a skill 51′, and points are paid in response. This type of services for providing skills include a community among members, a regular meeting, and a workshop instructed by a provider with a skill (such as asset management and PC operation).

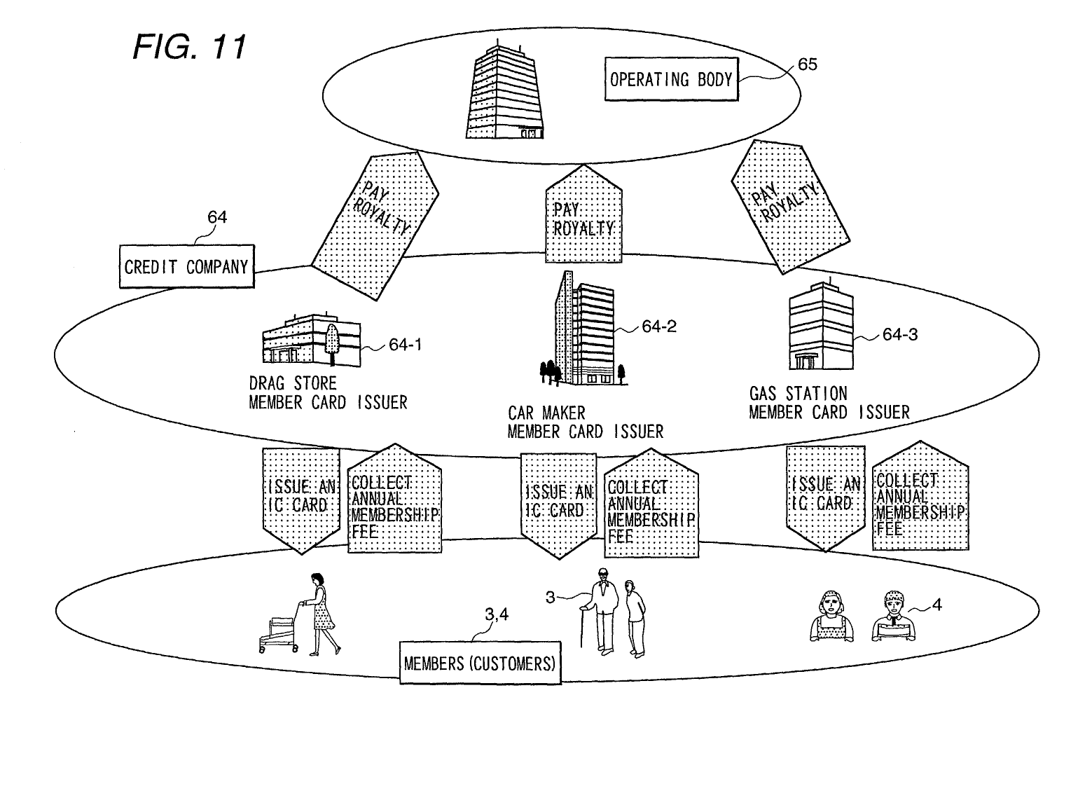

FIG. 11 describes a system for issuing IC cards. A credit company 64 (finance company) issues member certificates (IC cards) to customers who apply for member registration 3 and 4, and collects annual fees, and the credit company may be an existing company including a company for issuing drag store member cards, 64-1, a company for issuing car maker member cards 64-2, and a company for issuing gas station member cards 64-3. The credit company 64 pays a royalty to an operating body each time the IC card is issued. A member card issuing company (a credit card company which issues member cards for participant shops), which is an existing member contact, issues IC cards to the members, collects annual fees from the members, and pays the royalty to the operating body in this way. If a card company is not specified when one applies for a new membership, the operating body issues a card common to all participant shops. As this example, making an existing member card issuing company a member contact eliminates troubles of members for applying for a new card (filling a form, mailing, and investigation), and a waste of owning multiple cards. The credit card company provides a common point service and a needs matching service while the participant companies pay for cost of infrastructure of the IC cards.

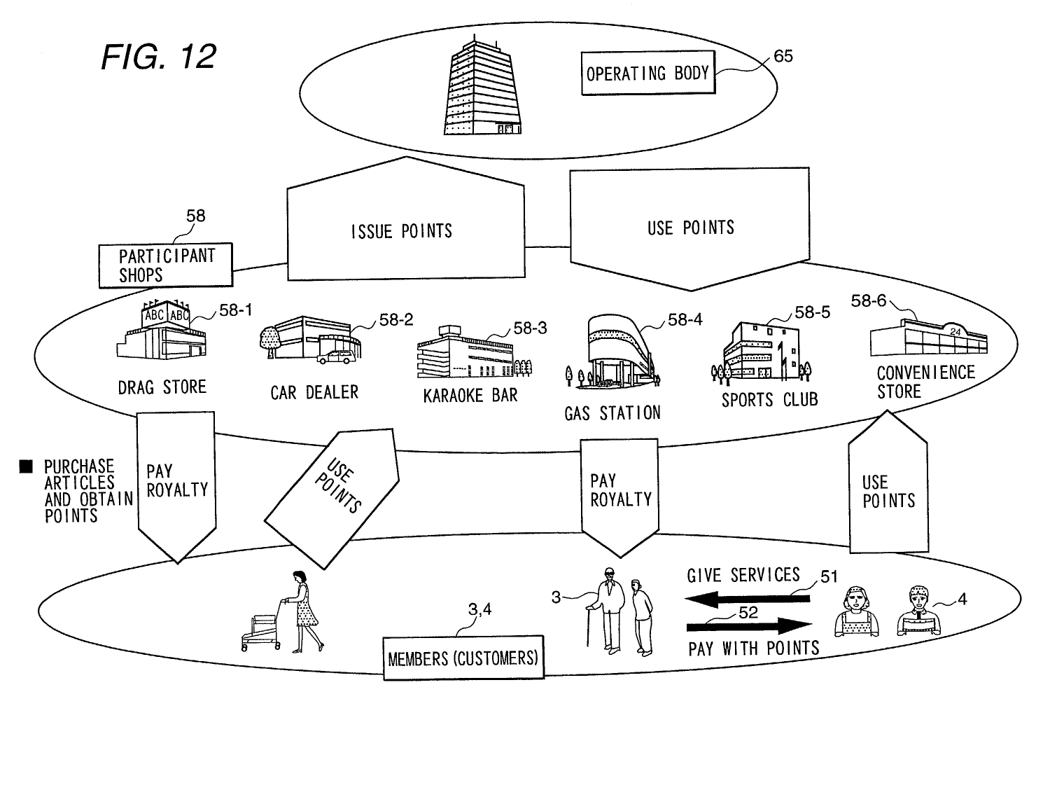

FIG. 12 describes a system for issuing points. The customer members 3 and 4 obtain points from participant shops 58 when they purchase articles, namely points are issued to them, and use the points as money for the purchase. The participant shops are participant shops where cards from so-called credit companies are available, and include a drag store 58-1, a car dealer 58-2, a karaoke bar 58-3, a gas station 58-4, a sports club 58-5, and a convenience store 58-6. The operating body 65 issues common points to these individual participant shops 58, and the operating body 65 purchases common points. The participant shops set conversion rates for the customers 3, and when the customer 4 who obtains pointed from the customer 3 who had received a service uses the points for purchasing something, the operating body 65 settles the points used by the customer 4.

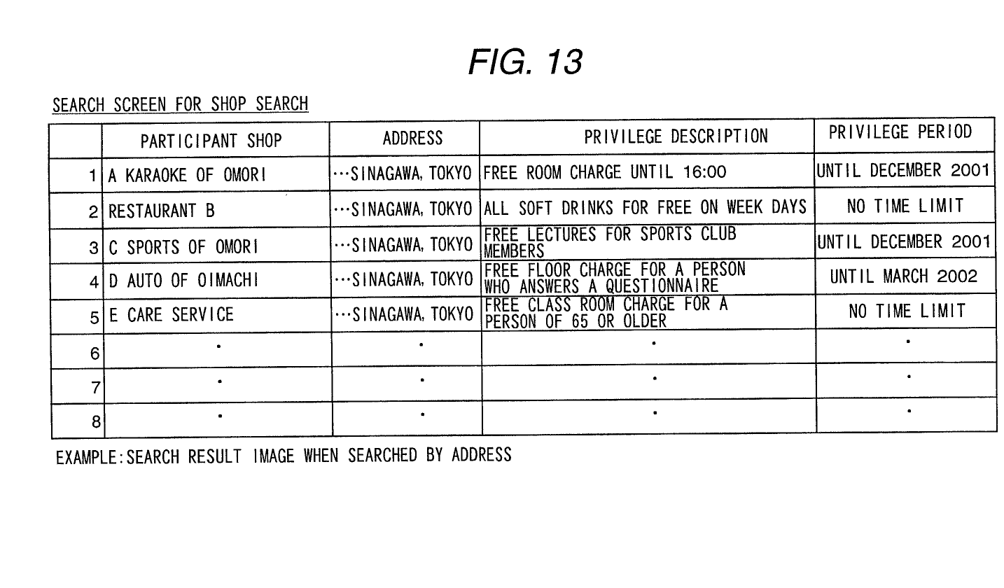

The following section describes a service when participant shop buildings (bases) are used. Buildings (bases) of the participant shops 58 as well as the residence of the service user 3 are used as a place where the service provider 4 provides the service user 3 with a service. Candidate of the shops include shops (bases) which has a spatial margin, and is intended for pulling visitors such as a karaoke bar, a restaurant, a sports club, a car dealer, a care business association facilities (schools for training care managers/helpers), and libraries as described before. Contents of the service include a place for passing over articles/payments, different types of workshops (such as how to use PC, how to manage assets, and consultation for care), and a community (such as a chatting companion, and friends who do something together). The shops will offer privileges for using conditions of the shop buildings (bases) such as a free room charge until 16:00 at a karaoke bar, free soft drinks on weekdays at a restaurant, a free charge at a care business association facility for 65 years old or older, and a free floor charge up to two hours after answering a questionnaire at a car dealer. A member uses the privileges and a search system allowing search by place, thereby increasing convenience of selecting a place. FIG. 13 shows an example of a search screen for an attached shop search. In this way, the members provide one another with a service while it is not required to disclose private information (address and contact information) when articles/payments are passed over between “seller/buyer” members. It is possible for participant shop buildings (sites) can pull visitors in a time zone when there are no visitors, obtain target customers, and obtain customer information to activate the shop buildings, and to extend sales.

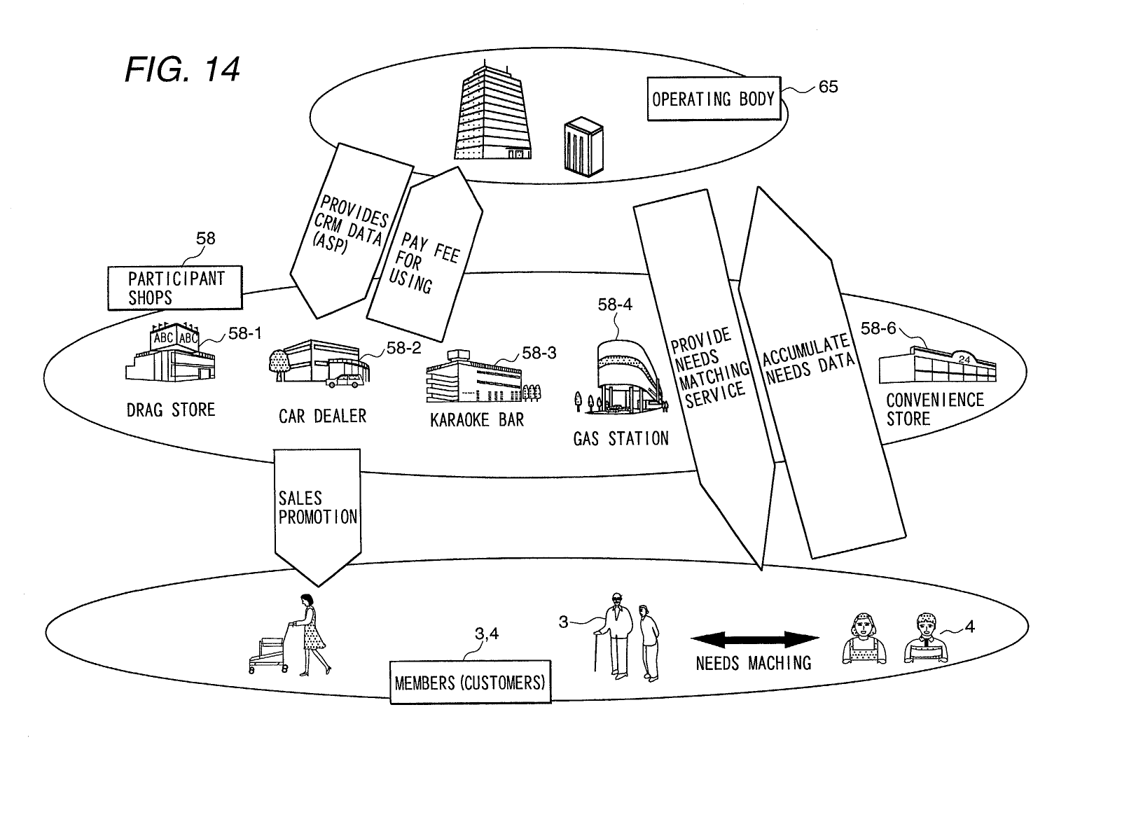

FIG. 14 describes how the participant shops 58 use CRM. The contents of the participant shops in the drawing are the same as those in FIG. 12. The participant shops conduct a sales promotion intended for the members (customers) 3 and 4. Needs are matched on the Internet between the members 3 and 4, and the resultant data are accumulated (CRM). The operating body 65 provides the participant shops with the needs matching data through an ASP (Application Service Provider), and the participant shops 58 use the data for the sales promotion, and pay user fees. The operating body 65 provides the members 3 and 4 with a needs matching service, and receives and accumulate the needs data in return.

The CRM service where needs matching data are accumulated, and are used for sales promotion of the participant shops is provided in the example in FIG. 14. Though the conventional CRM in the distribution sector focuses on the purchase analysis for articles, accumulating needs matching data enables needs analysis. It is possible for a karaoke bar/a restaurant to hold a community, and it is possible for a travel agency to deploy a promotion such as a joint tour to target customers when there is a need for females with age from ◯◯ to ◯◯ as a chatting companion.

The credit company 64 switches from a magnetic card to an IC card when the needs matching service members 3 and 4 are registered in the embodiment described above. The company can obtain welfare/care relating company customers and NPO/NGO members as new members. The company can obtain a charge for collecting annual fees as an income.

Sharing points among different industries increase the convenience of the points for the individual members 3 and 4, provides the service users with a contact for solving needs, and provides chances to obtain points for the service providers.

The points shared among different industries allow distribution companies to enclose customers, and customers are shared among different industries. Designating service bases and shops as intermediary bases for the needs matching (such as communities, workshops, and selling/purchasing articles) pulls visitors, thereby increasing sales. The needs matching CRM enables not the article purchase analysis, but the sales extension promotion.

The care business associations can be customers as the service users 3, the care business associations can use the needs matching service to cover a care insurance service (such a chatting companion, PC operation training, and asset management). Further, utilizing facilities of the care business associations as workshop sites allows using the facilities efficiently, and enclosing users (candidate care receivers, and customers of other care business associations).

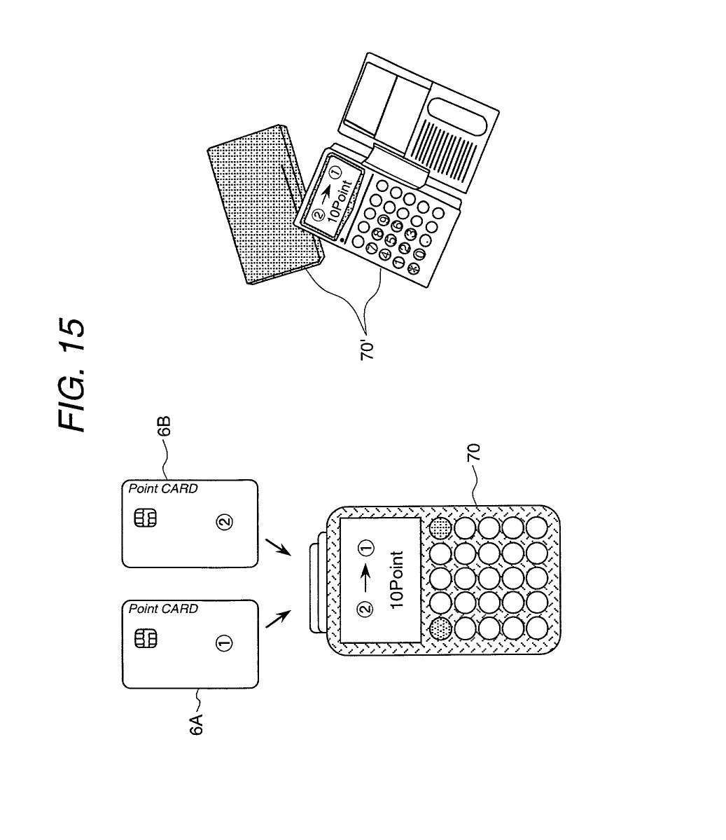

FIG. 15 to FIG. 21 are examples of devices for moving points from an IC card 6B of the service user to an IC card 6A of the service provider. FIG. 15 shows an example of moving points from an IC card 6B of the service user to an IC card 6A of the service provider with a portable point exchange machine 70 (portable convenient for bringing). The point exchange machine 70 is a dedicated portable machine, both cards are inserted simultaneously into the point exchange machine 70, and an electronic wallet 70′ can be used for inserting/extracting the individual cards. In both cases, the moved points are shown on a display.

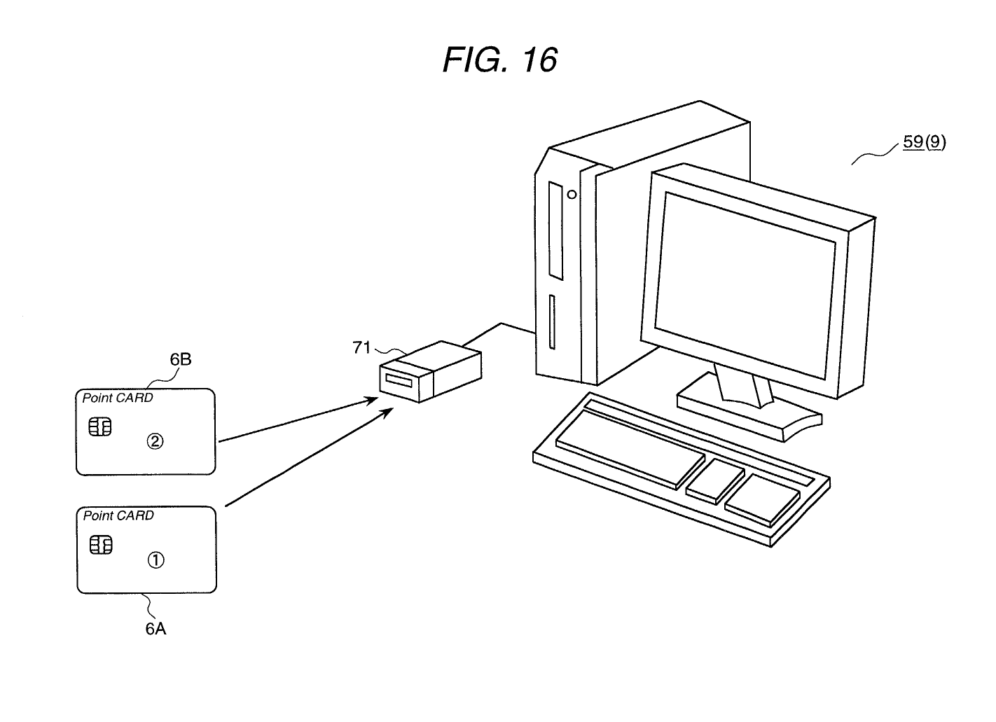

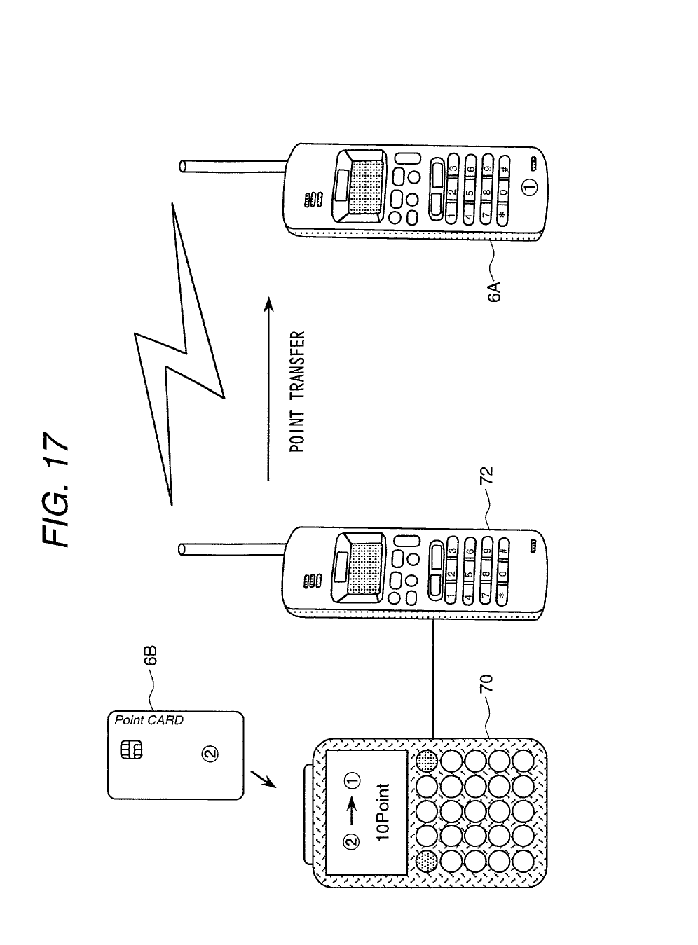

FIG. 16 shows an example of a stationary machine, an IC card R/W for a point exchange machine 71 is connected with a personal computer 7 of a member, and individual cards 6B and 6A are inserted sequentially or simultaneously to move points. FIG. 17 shows an example for moving points from the card 6B to a cellular phone for a member 6A, a card 6B is inserted into a point exchange machine 70 (portable, dedicated machine), the exchange machine 70 is connected with a general cellular phone 72, communication between the cellular phones moves points to the cellular phone for a member with a 6A feature.

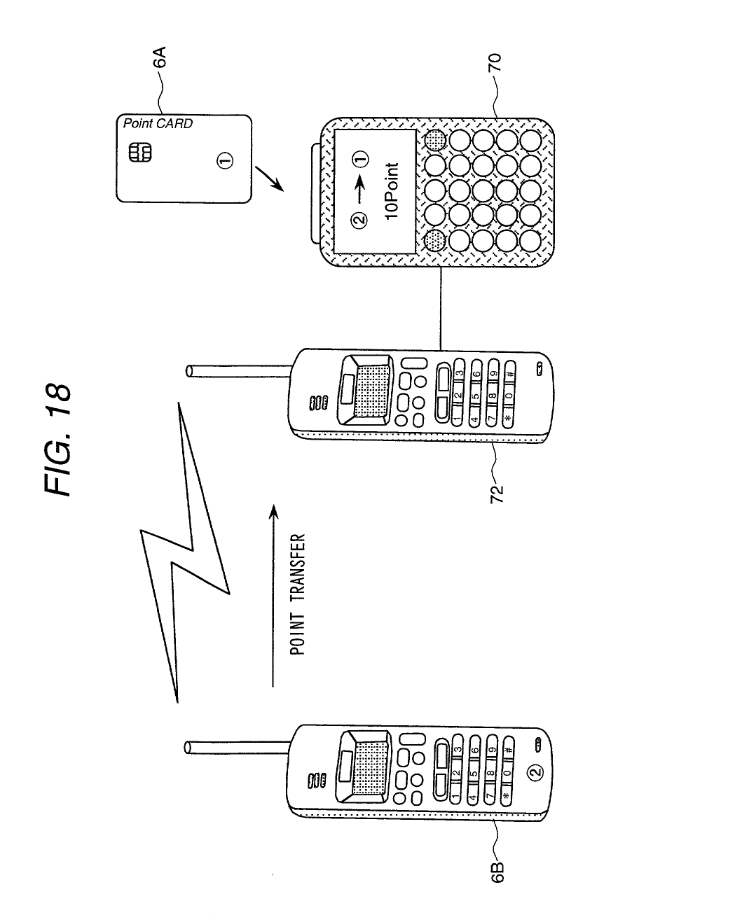

FIG. 18 shows an example for moving points from a cellular phone for a member 6B to a general cellular phone 72 connected with an exchange machine 70, which is the reverse of FIG. 17, and a card 6A is inserted into the dedicated exchange machine 70.

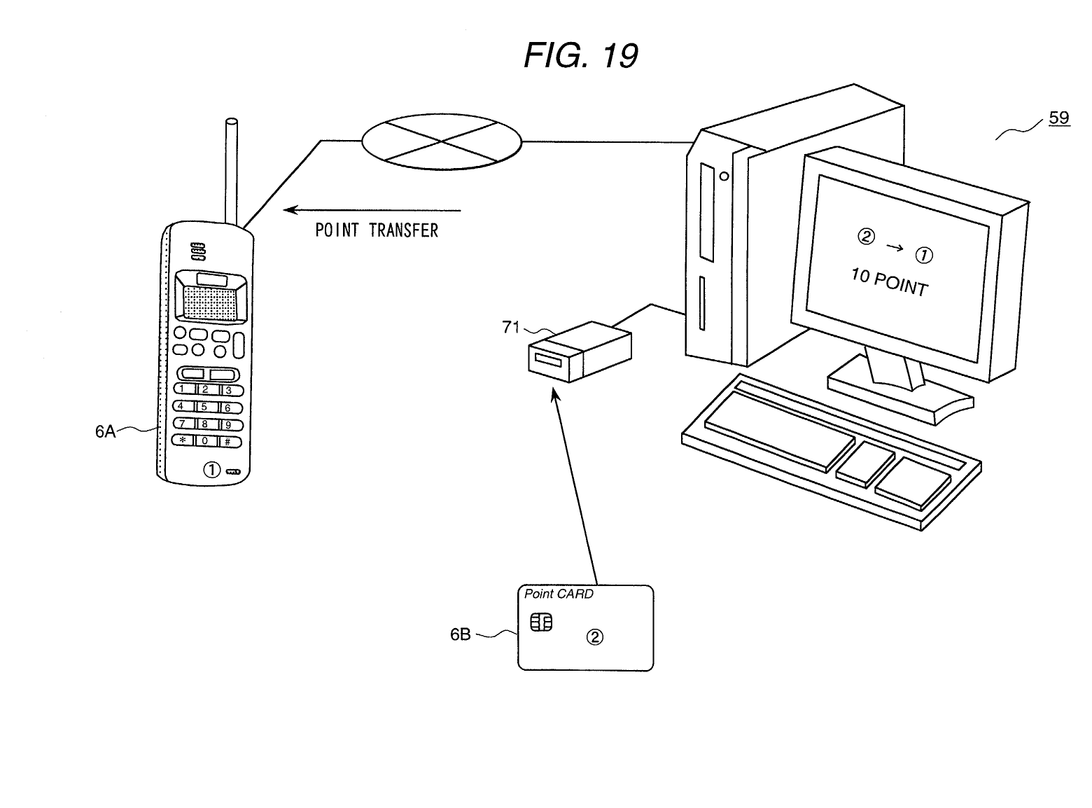

FIG. 19 shows an example for moving points to a cellular phone for a member 6A while a card 6B is inserted into an IC card R/W for a point exchange machine 71 connected with a PC 7 for a member.

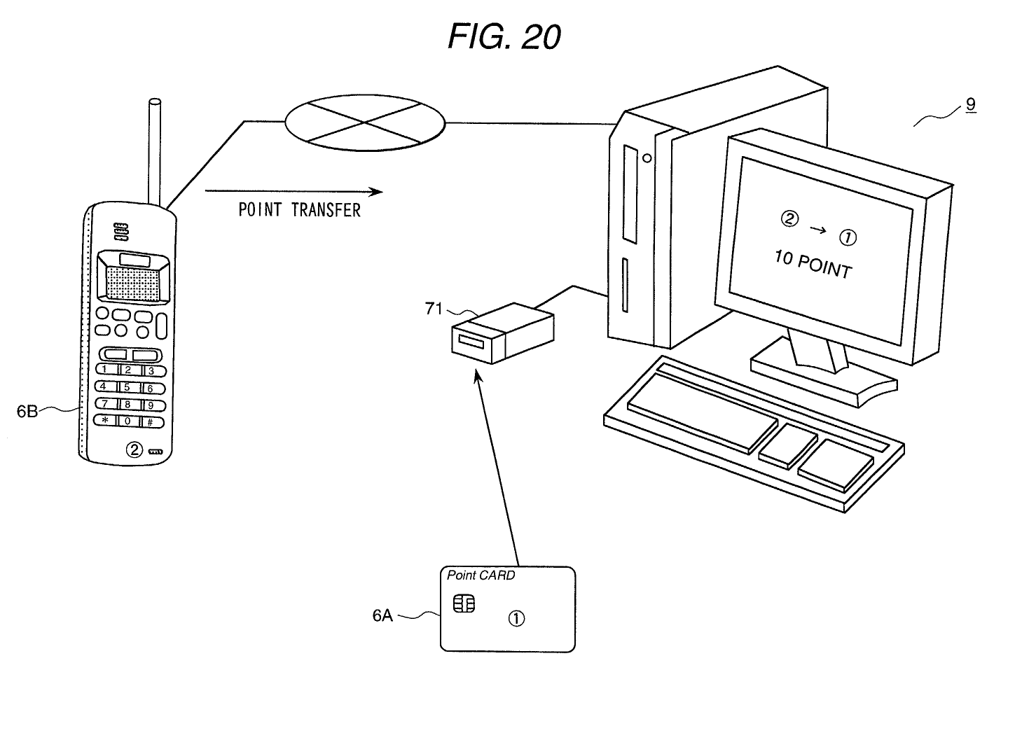

FIG. 20 show an example where a cellular phone for a member has the 6B feature, an IC card has the 6A feature, and the card 6A is inserted into the dedicated R/W 71, which is the reverse of FIG. 19.

FIG. 21 shows an example where both the 6A feature and the 6B feature are added to cellular phones, and points are exchanged between them.

As describe above, the present invention has an effect that supplying the service provider with points according to the degree of a service from the service provider increases the number of the service providers, and further activates the service by means of using accumulated points.

What is claimed is:

1. A point managing method wherein terminals of individual members of multiple service users and service providers registered as members, and terminals of a hosting business association are connected with communication mean, member information recording media which can be attached to the terminals of the individual members are delivered, prescribed points are given to the service provider through said terminal and said recording medium when the service user receives a service from the service provider, and a service is received, or an article is purchased or lent based on point conversion according to said accumulated points.

2. A point managing method wherein terminals of individual members of multiple service users and service providers registered as members, and terminals of an operating business association are connected with communication mean for communicating, said operating business association or its agent delivers member information to said terminals of the individual members, or delivers member information recording media which can be attached to terminals of the individual members, prescribed points are given to the service provider through said terminal and/or said recording medium when the service user receives a service from the service provider, and a service is received, or an article is purchased or lent based on point conversion according to said accumulated points.

3. A point managing method wherein terminals of individual members of multiple service users and service providers registered as members, and terminals of a hosting business association are connected with the Internet, member information recording media which can be attached to the terminals of the individual members are delivered, prescribed points are given to the service provider through said terminal by means of writing to said recording medium when the service user receives a service from the service provider, and a service is received, or an article is purchased or lent based on point conversion according to said accumulated points.

4. A point managing method wherein terminals of individual members of multiple service users and service providers registered as members, and terminals of an operating business association are connected with the Internet for communicating, said operating business association or its agent delivers member information to said terminals of the individual members, or delivers member information recording media which can be attached to terminals of the individual members, prescribed points are given to the service provider through said terminal and/or said recording medium when the service user receives a service from the service provider, and a service is received, or an article is purchased or lent based on point conversion according to said accumulated points.

5. The point managing method according to any one of claim 1 to 4 wherein said recording media are IC cards or cellular phones, and a member certificate function and/or a member authentication function are added to said recording media.

6. The point managing method according to any one of claim 1 to 5 wherein the service provider is a care giver, and the service user is a care receiver.

7. A point management method wherein both service users and service providers are members, an electronic medium is issued to individual members, a need of the service user and a service which the service provider can provide are matched, the matching result is reported to both the subject members, points are provided for the service provider according to a conducted service, the points can be used at available participant stores, and the used points are settled by an operating body.

8. The point management method according to claim 7 wherein issuing said electronic medium is delivering an IC card.

9. The point management method according to claim 7 wherein issuing said electronic medium is delivering information to portable terminals of members for making the portable terminals member certificates.

10. The point management method according to claim 7 wherein the service user provides the service provider with the points.

11. The point management method according to claim 7 wherein said service is conducted at a residence of the service user and/or a building of the participant shop.

12. The point management method according to claim 7 wherein a CRM service using data from said matching is provided for the participant shop.

13. The point management method according to claim 7 wherein said terminal or an alternative terminal can be used for searching the service by privilege, address, and/or using period when the service provider selects said participant shop as a place to conduct the service.

14. A point management method wherein both service users and service providers are members, an electronic medium is issued to individual members, a need of the service user and a service which the service provider can provide are matched, the matching result is reported to both the subject members, the service provider is guided to a residence of the user by a navigation system, points are provided for the service provider according to the conducted service, the points can be used at available participant stores, and the used points are settled by an operating body.

15. The point management method according to claim 14 wherein issuing said electronic medium is delivering an IC card.

16. The point management method according to claim 14 wherein issuing said electronic medium is delivering information to portable terminals of members for making the portable terminals member certificates.

17. The point management method according to claim 14 wherein the service user provides the service provider with the points.

18. The point management method according to claim 14 wherein said service is conducted at a residence of the service user and/or a building of the participant shop.

19. The point management method according to claim 14 wherein a CRM service using data from said matching is provided for the participant shop.

20. The point management method according to claim 14 wherein said terminal or an alternative terminal can be used for searching the service by privilege, address, and/or using period when the service provider selects said participant shop as a place to conduct the service.
